(19) United States
(12) Patent Application Publication
(10) Pub. No.: US 2013/0322348 A1
(43) Pub. Date: Dec. 5, 2013

(54) CHANNEL SWITCHING SCHEME FOR WIRELESS COMMUNICATION

(71) Applicants: David Jonathan Julian, San Diego, CA (US); Arvind Subramanian Krishna, San Diego, CA (US); Rahul Anand, San Diego, CA (US); Brian Michael Buesker, San Diego, CA (US)

(72) Inventors: David Jonathan Julian, San Diego, CA (US); Arvind Subramanian Krishna, San Diego, CA (US); Rahul Anand, San Diego, CA (US); Brian Michael Buesker, San Diego, CA (US)

(73) Assignee: QUALCOMM Incorporated, San Diego, CA (US)

(21) Appl. No.: 13/485,712

(22) Filed: May 31, 2012

(51) Int. Cl. H04W 72/04

(52) U.S. Cl. 370/329

(57) ABSTRACT

In a channel switching scheme for wireless communication, when a wireless device transmitting and/or receiving user data of a first type via a first channel needs to switch to transmitting and/or receiving user data of a second type, a second channel is established for the second type of user data. To reduce latency and interference that may otherwise be associated with such a switch, at least one parameter for communicating on the second channel is sent over the first channel. The wireless device that receives the parameters(s) may immediately commence taking action to switch to the second channel. In addition, the wireless device that sent the parameter(s) may concurrently tear down the first channel while establishing the second channel.

### BACKGROUND

1. Field

This application relates generally to wireless communication and more specifically, but not exclusively, to a low latency scheme for switching between channels.

2. Introduction

Wireless communication devices communicate with one another via one on more channels established between the devices. The manner in which a channel is established depends in some aspects on the wireless communication technology employed. For example, for ultra-wideband (UWB) communication employing impulse-based signaling, different channels may be established through the use of different channel parameters such as different pulse repetition rates and different pulse position time hopping sequences. Other forms of channel definitions are employed for other wireless communication technologies (e.g., time division multiplexed channels, code division multiplexed channels, and so on).

Wireless communication devices may use different channels to carry different types of data. For example, a wireless headset may receive audio data streams, voice data streams, video data streams, or other types of data streams from a host device (e.g., a cell phone, a personal entertainment device, a computer, etc.). Accordingly, one channel may be established to carry the audio data stream, another channel may be established to carry the voice data stream, and so on.

In some deployments, a wireless device will need to switch from one channel to another channel to accommodate a different data stream. For example, when a user is listening to audio (e.g., music) transmitted from a handset device (e.g., a cell phone, etc.) to a headset device, the user may get a voice call. Conversely, when the voice call terminates, a user may wish to switch back to listening to music. Here, the audio may be carried by a one-way audio channel that is optimized for transmitting music from the handset to the headset, while the voice is carried by a voice channel optimized for bi-directional voice communication. Accordingly, a channel switch is needed to accommodate these different types of data streams.

In some deployments, the devices will switch from one channel to another (e.g., from an audio channel to a voice channel) by tearing down the active channel and then establishing the other channel. In practice, such channel switching may result in an unacceptable user experience. For example, latency associated with switching from one channel to another by tearing down the first channel and then establishing the second channel may result in a relatively long “dead air” period where the user does not hear audio from either channel. In addition, a user may hear audio artifacts (e.g., clicks and pops) when switching between channels in this manner.

Alternatively, in other deployments, the devices may keep both channels active even when there is no traffic on a given channel. Such an approach may reduce the latency associated with switching between channels. However, this approach is inefficient since it results in increased power consumption at the wireless devices and reduces the amount of radio frequency spectrum resources available to other wireless devices since the active channels will result in increased interference in the system.

In view of the above, a need exists for more effective techniques for switching between channels used by wireless communication devices.

### SUMMARY

A summary of several sample aspects of the disclosure follows. This summary is provided for the convenience of the reader and does not wholly define the breadth of the disclosure. For convenience, the term some aspects may be used herein to refer to a single aspect or multiple aspects of the disclosure.

The disclosure relates in some aspects to switching between channels established for wireless communication. For example, when a wireless device transmitting and/or receiving user data of a first type via a first channel needs to switch to transmitting and/or receiving user data of a second type, a second channel is established for the second type of user data. To reduce latency associated with such a switch, at least one parameter for communicating on the second channel is sent over the first channel. That is, the parameter is (or the parameters are) transmitted in-band, rather than on a separate control channel.

Advantageously, the wireless device (e.g., a first wireless device) that receives the parameters(s) may immediately commence taking action to switch to the second channel. For example, in a case where a parameter is a decoder parameter, the wireless device will commence configuring its decoder to support the second channel while optionally taking steps to ramp down any audio output that is based on user data received via the first channel.

Moreover, the wireless device (e.g., a second wireless device) that sent the parameter(s) may concurrently tear down the first channel while establishing the second channel. The wireless device is able to perform these operations concurrently through the use of an appropriate trigger for commencing the operations. In some implementations, these operations are commenced upon receipt of an acknowledgement message from the other wireless device while the other wireless device is switching from the first channel to the second channel. Alternatively, these operations are commenced a defined period of time after sending the parameter(s) to the other wireless device.

Through the use of these and other aspects of the disclosure discussed herein, the wireless devices are able to switch channels with low latency (e.g., less than 100 milliseconds), and without requiring that both channels remain active. For example, latency associated with the switch to a different channel may be reduced since parameters that provide the initial indication of the switch may be sent without establishing a control channel for sending the parameters. Also, such parameters may be sent without first tearing down the first channel. Moreover, the wireless devices may commence tearing down the first channel while taking steps to establish the second channel. Furthermore, sending user data and parameters over a single active channel eliminates inter-channel interference that could otherwise result from sending the parameters over an active control channel while there is an active data channel. Consequently, wireless devices constructed in accordance with the teachings herein may consume less power, cause less interference, and provide a better user experience as compared to conventional wireless devices.

In view of the above, an apparatus, method, or computer-program product implemented in accordance with the teachings herein may provide or be used to provide functionality relating to switching channels for wireless communication. In some aspects, such functionality involves: receiving control data and user data on a first channel, wherein the control data comprises at least one parameter for communicating on a second channel; and establishing the second channel based on the at least one parameter. In some aspects, such functionality involves: transmitting control data and user data on a first channel, wherein the control data comprises at least one parameter for communicating on a second channel; and establishing the second channel after the transmission of the control data and the user data.

### BRIEF DESCRIPTION OF THE DRAWINGS

These and other sample aspects of the disclosure will be described in the detailed description and the appended claims that follow, and in the accompanying drawings, wherein:

FIG. 1 is a simplified block diagram of several aspects of a sample communication system comprising wireless devices configured to switch between channels in accordance with the teachings herein;

FIG. 2 is a simplified timing diagram of several aspects of a sample messaging scheme for switching between channels in accordance with the teachings herein;

FIGS. 3 and 4 are a flowchart of several sample aspects of operations that may be performed by an apparatus (e.g., a wireless device) to switch between channels in accordance with the teachings herein;

FIGS. 5 and 6 are a flowchart of several sample aspects of operations that may be performed by another apparatus (e.g., another wireless device) to switch between channels in accordance with the teachings herein;

FIG. 7 is a simplified block diagram of several sample components that may be employed in a communication apparatus;

FIG. 8 is a simplified block diagram of several sample aspects of communication components; and

FIGS. 9 and 10 are simplified block diagrams of several sample aspects of apparatuses configured to support channel switching as taught herein.

In accordance with common practice the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect taught herein may comprise at least one element of a claim.

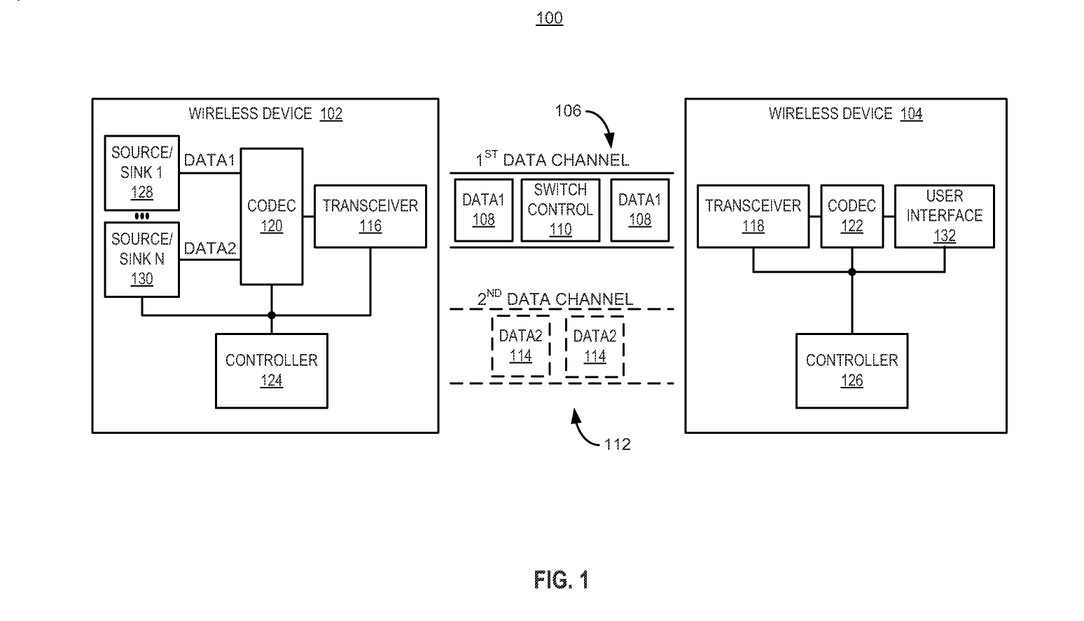

FIG. 1 illustrates an example of a communication system 100 that includes two wireless devices 102 and 104. For purposes of illustration, the wireless device 102 may be described herein as embodying a wireless handset while the wireless device 104 may be described herein as embodying a wireless headset. It should be appreciated, however, that the wireless devices 102 and 104 are not limited to these implementations.

A user of the wireless device 104 receiving a first type of data service (e.g., streamed music) from the wireless device 102 will, on occasion, need to switch over to a second type of data service (e.g., a phone call). The application relates in some aspects to techniques for reducing latency and/or interference that may otherwise be associated with such a switch and, in some cases, reducing unwanted artifacts (e.g., audible pops or clicks) that could otherwise occur during such a switch.

The first type of service is established over a first data channel 106 (e.g., an audio channel). For example, communication components of the wireless devices 102 and 104 (discussed below) may be configured to establish a channel that is optimized for audio streaming. As illustrated in FIG. 1, data1 (e.g., from source/sink 128) is being sent over the first data channel 106.

Of note, the second data channel 112 shown in phantom in FIG. 1 is not yet established at this point. Hence, there is no power consumption or interference associated with the second data channel 112 at this point.

At some point in time, the wireless device 102 determines that a switch to the second service should be initiated. For example, a user of the wireless device 102 may initiate a phone call or the wireless device 102 may receive signaling associated with an incoming phone call.

Upon determining that a switch in service is needed, the wireless device 102 transmits control data indicative of the switch to the wireless device 104. In accordance with the teachings herein, the control data (e.g., represented by switch control 110 in FIG. 1) is sent with user data on the first data channel 106. That is, the control data is transmitted in-band with the user data rather than on a separate control channel. For example, the audio data for the first data channel 106 and the control data (e.g., parameters) associated with the second data channel 112 may be transmitted in the same packet, in different packets, or in a common set of packets on the first data channel 106.

In some implementations, the control data comprises hardware and/or software parameters that the wireless device 104 will use for providing the second service on the second data channel 112. For example, in some cases, the control data comprises audio decoder parameters that are used to configure an audio decoder at the wireless device 104 (discussed below). Typically, the first and second data channels 106 and 112 have different characteristics (e.g., a given data channel is optimized for the data being carried by that data channel). As an example, the second data channel 112 may be a two way channel (e.g., audio information sent in both directions), whereas the first data channel 106 might be a one way channel or might send audio in only one direction and control information in both directions.

In practice, the transmission of the control data may be unreliable due to the use of a data channel instead of a more reliable control channel. Consequently, the control data may be repeatedly sent over the first data channel 106 to increase the likelihood that the wireless device 104 will receive the control data.

Receipt of the control data at the wireless device 104 provides an indication (e.g., explicitly or implicitly) that the wireless device 104 is to switch to the second data channel 112. Thus, after receiving the control data, the wireless device 104 may commence gracefully tearing down the first data channel 106 to ensure a smooth transition between services. For example, the wireless device 104 may fade out (e.g., ramp down) the volume of the audio for the first streaming service after it has received the control data interspersed with the user data on the first data channel 106.

In addition, after receiving the control data, the wireless device 104 commences hardware and/or software configuration for the second data channel 112. Typically, this involves configuring an audio codec of the wireless device 104. Of significance, the wireless device 104 commences configuring the audio codec before receiving a channel setup message (e.g., a channel establishment procedure) from the wireless device 102.

Also after receiving the control data, the wireless device 104 may send an indication to the wireless device 102 that indicates that the first device has commenced tearing down the first data channel 106. In some cases, this indication is in the form of an acknowledgement message that acknowledges receipt of the control data.

After transmitting the control data and user data on the first data channel 106, the wireless device 102 commences establishing the second data channel 112 and configuring a codec for the second data channel 112. In conjunction with establishing the second data channel 112, the wireless device 102 sends a channel setup message to the wireless device 104 (e.g., comprising an instruction to establish the second data channel 112). Such a message may include, for example, RF channel definitions (e.g., encoding and timing parameters) to be used for communication via the second data channel 112.

In some embodiments, the wireless device 102 reduces switching latency by conducting concurrent operations to tear down the first data channel 106 and establish the second data channel 112. In some embodiments, commencement of these operations is triggered by receipt of an appropriate indication (e.g., an acknowledgement message) from the wireless device 104. In some embodiments, these operations are commenced a defined period of time after the wireless device 102 transmits the control data indicating the channel switch.

Once the second data channel 112 is established, the wireless devices 102 and 104 commence communicating over the channel. For example, as shown in FIG. 1, data2 114 (e.g., from the source/sink 130) is sent over the second data channel 112.

The use of in-band signaling to send channel switching information may provide several advantages over conventional channel switching schemes. In particular, power consumption, interference, and latency that would otherwise be associated with the use of a separate control channel for sending control data (e.g., decoder parameters) that provides an initial indication of a switch to a different channel may be eliminated or otherwise reduced. For example, interference to an existing audio channel (or voice channel) that would result if both user data and control channels were active when the device is near the edge of coverage may be avoided. Moreover, power consumption of the wireless devices is reduced since the overhead associated with establishing and maintaining (e.g., paging operations) an out-of-band control channel for the initial switch indication is eliminated. In addition, as the control data is sent in-band, there is no delay associated with establishing another channel and, in some cases, paging a wireless device to send the switch information. Consequently, there is less latency associated with the switch in this case. This shorter latency period, in turn, provides a better user experience during switching since there will be a relatively short delay from the time the audio (from the user data on the first data channel 106) fades out at a user interface (e.g., a speaker) to the time the caller's voice (from the user data on the second data channel 112) is heard at the user interface.

As mentioned above, the wireless devices 102 and 104 include various components to support the transmission of data between the devices. In general, basic operations of such components are known in the art. Several examples of functionality provided by these components in conjunction with establishing channels and switching between channels will be treated briefly.

The wireless devices 102 and 104 include transceivers 116 and 118, respectively, for communicating with one another via radio frequency (RF) signaling over one or more channels. In some embodiments, the transceivers 116 and 118 are configured for UWB communication. In this case, the transceivers 116 and 118 will be configured with different radio frequency parameters (e.g., pulse repetition period, hopping sequence, etc.) to establish different channels. In other embodiments, the transceivers 116 and 118 employ other types of wireless communication technologies where different channels are established using other parameters (e.g., PN codes, time slots, frequencies, etc.).

The wireless device 102 includes a plurality of data source and/or data sink components (represented by source/sink 128 and source/sink 130) for providing data to be sent to the wireless device 104 and for processing (e.g., outputting or forwarding) data received from the wireless device 104. A given data source component may provide local data (e.g., data stored locally in a memory device or provided by a local user interface) or data that is received from another device (e.g., via a wired or wireless link, not shown). Similarly, a given data sink component may output data locally (e.g., via a local user interface) or send data to another device (e.g., via a wired or wireless link, not shown).

The wireless device 102 includes a codec 120 to process data received via the transceiver 116 or data to be transmitted by the transceiver 116. An encoder component (not shown) of the codec 120 encodes data provided by a data source component (e.g., source/sink 128) to facilitate transmission of the data via the transceiver 116. Conversely, a decoder component (not shown) of the codec 120 decodes data received via the transceiver 116 to facilitate processing of the data by a data sink component (e.g., source/sink 128). In general, these components will be configured in a different manner to support different types of data. For example, one type of encoding may be employed for audio playback (e.g., streaming audio data), while another type of encoding is employed for a phone call (e.g., streaming speech data).

The wireless device 104 includes a user interface 132 that serves as a source/sink component for providing data to be sent to the wireless device 102 and for processing (e.g., outputting) data received from the wireless device 102. In some implementations, the user interface 132 comprises a microphone and at least one speaker (e.g., for a headset). In some implementations, the user interface 132 comprises a microphone, at least one speaker, a display device, and a camera (e.g., for a video system). In some implementations, the user interface 132 comprises one or more of the above components and/or some other component(s).

The wireless device 104 also includes a codec 122 to process data received via the transceiver 118 or data to be transmitted by the transceiver 118. An encoder component (not shown) of the codec 120 encodes data provided by the user interface 132 to facilitate transmission of the data via the transceiver 118. Conversely, a decoder component (not shown) of the codec 122 decodes data received via the transceiver 118 to facilitate outputting of the data by the user interface 132. As above, these components will be configured in a different manner to support different types of data.

The wireless devices 102 and 104 also include controllers 124 and 126, respectively, for controlling the operations of the other components and for performing other operations. For example, the controllers 124 and 126 may communicate with one another and reconfigure the transceivers 116 and 118 and the codecs 120 and 122 to establish channels between the wireless devices 102 and 104 and control any switch from one channel to another.

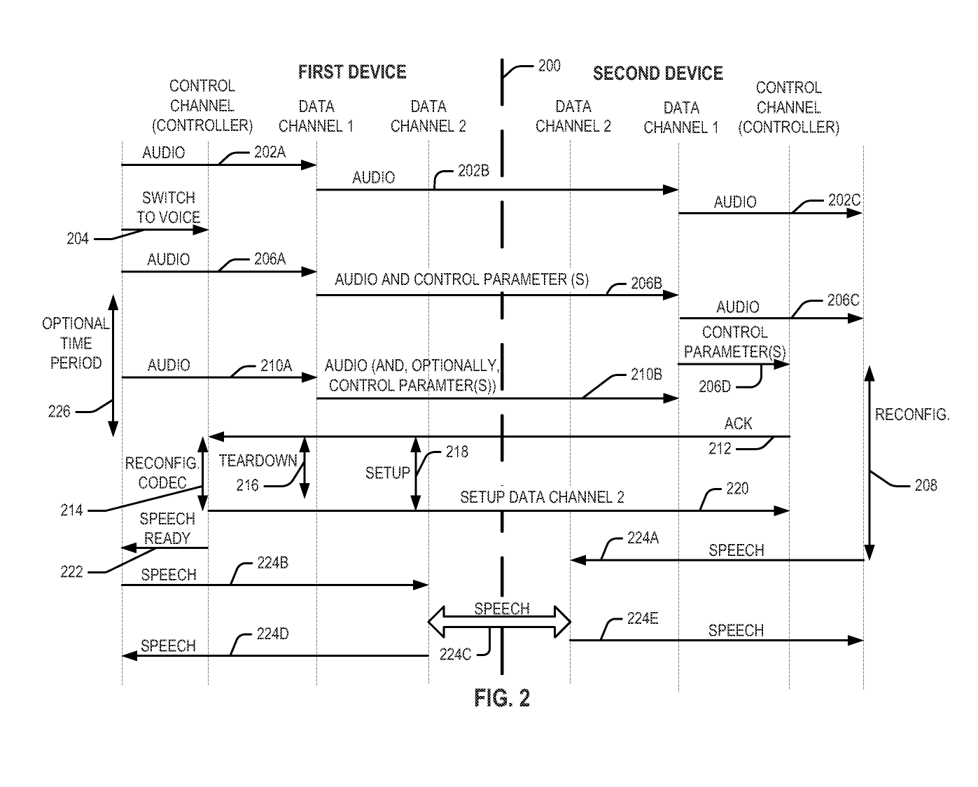

FIG. 2 illustrates an example of messaging operations that may be employed to switch channels in accordance with the teachings herein. For purposes of illustration, the example of FIG. 2 describes a scenario where unidirectional audio is initially sent over a first data channel and, following a channel switch, bi-directional speech is sent over a second data channel. It should be appreciated, however, that similar messaging may be employed in other scenarios to send different types of data, to switch among different types of channels, and to switch among a different number of channels (i.e., more than 2).

For convenience, the operations of FIG. 2 (or any other operations discussed or taught herein) may be described as being performed by specific components (e.g., the components of FIG. 1). It should be appreciated, however, that these operations may be performed by other types of components and may be performed using a different number of components. It also should be appreciated that one or more of the operations described herein may not be employed in a given implementation.

In FIG. 2, a vertical line 200 represents a separation between functionality associated with a first device and a second device. In some aspects, the other vertical lines in FIG. 2 represent message (e.g., packet) origination points or end points.

Starting at the top of the timing diagram, it is assumed that the first data channel (data channel 1) is already established. Thus, as represented by the arrow 202A, audio data (e.g., from a data source) is provided for transmission over data channel 1. The transmission of this audio data over data channel 1 is represented by the arrow 202B. As represented by the arrow 202C, at the second device, the audio data is sent to a data sink.

As represented by the arrow 204, at some point in time a switch to voice is indicated. For example, as discussed herein, a controller of the first device may receive an indication that a call is being initiated by the first device or incoming call signaling has been received by the first device.

As represented by the arrow 206A, audio data (e.g., from the same data source that provided the audio data corresponding to the arrow 202A) is again provided for transmission over data channel 1. In this case, however, the audio data is sent over data channel 1 with one or more control parameters as represented by the arrow 206B. As discussed herein, in some aspects, a control parameter indicates a switch to data channel 2. For example, the control parameter(s) may comprise one or more parameters for configuring a decoder and/or an encoder as discussed herein. As another example, the control parameter(s) may indicate the sampling rate for the stream, whether the stream is unidirectional or bidirectional, and microphone information (e.g., which microphones will be enabled).

As represented by the arrow 206C, at the second device, the audio data is again sent to a data sink. In addition, the control parameter(s) is/are sent to a controller for the second device as represented by the arrow 206D.

As a result of receiving the control parameter(s), the second device commences reconfiguration operations to switch to data channel 2 as represented by the arrow 208. For example, the second device may ramp down the audio output associated with data channel 1, flush any buffers that contain user data for data channel 1, and then reconfigure the audio codec using the received parameter(s).

As represented by the arrows 210A and 210B, the first device may still be transmitting audio data over data channel 1 (e.g., from the same data source that provided the audio data corresponding to the arrows 202A and 206A). As indicated for arrow 210B, the audio data sent over data channel 1 may again be interspersed with control data in scenarios where the control data is sent repeatedly in an attempt to ensure receipt at the second device. At some point (e.g., after the audio output at the second device is ramped down), the audio data sent over data channel 1 will not be forwarded to the data sink of the second device.

As represented by the arrow 212, in some implementations, the second device sends an acknowledgement to the first device via a control channel. As discussed herein, this acknowledgement may acknowledge receipt of the control parameter(s). In some cases, the message provides an indication that the second device is tearing down data channel 1. Such an indication may advantageously be used to inform the first device that it may stop sending user data over data channel 1 since the second device has taken steps to ensure that the user will not hear undesirable audio artifacts when this data stream stops (e.g., due to the second device ramping down the volume for data channel 1).

As indicated in FIG. 2, the control channel is a different channel than data channel 1. Here, the devices may use a control channel that was a previously established (e.g., for other signaling) or the devices may establish a new control channel for sending the acknowledgement.

As a result of receiving the acknowledgement, the first device commences reconfiguration operations to switch to data channel 2. As represented by the arrow 214, the first device reconfigures the audio codec to be used for data channel 2. As represented by the arrow 216, the first device starts tearing down data channel 1. As represented by the arrow 218, the first device commences setting up data channel 2. For example, the first device may configure its transceiver with the RF parameters (e.g., encoding and timing parameters) to be used for channel 2 transmissions. As FIG. 2 illustrates, these operations are performed at least partially in parallel. Accordingly, a device employing such a messaging scheme will have a lower latency switching procedure as compared to devices that first completely tear down one channel and then commence establishing the other channel.

As represented by the arrow 220, the first device sends a message to the second device via a control channel (e.g., the same control channel used for the acknowledgement), where the message includes one or more RF parameters to be used by the second device for establishing data channel 2. For example, as discussed above, these parameters may comprise encoding and timing parameters for the transceiver of the second device. In addition, the message may comprise an explicit instruction to the second device to establish data channel 2. Here, it will be appreciated that the second device has already commenced some reconfiguration operations (e.g., reconfiguring the audio codec) prior to receiving this message. Accordingly, the messaging scheme of FIG. 2 provides a lower latency switching procedure as compared to procedures that completely tear down one channel before establishing another channel.

After receiving the RF parameter(s), the second device completes its establishment of data channel 2. At this point (e.g., at the point in time corresponding to the bottom of the arrow 208), data channel 1 will be torn down at the second device.

As represented by the arrow 222, once data channel 2 is setup (and the tear down of data channel 1 complete), the controller of the first device provides an indication to the data source that speech streaming may commence. Thus, as represented by the arrows 224A, 224B, 224C, 224D, and 224E, the first device and the second device exchange speech data with one another via data channel 2.

As mentioned above, in some implementations, a device that initiates a channel switch does not wait for an acknowledgement to commence reconfiguration operations. For example, as represented by the arrow 226, in such an implementation, the first device may commence reconfiguration operations (e.g., represented by the arrows 214, 216, and 218) a defined period of time after sending the control parameter(s).

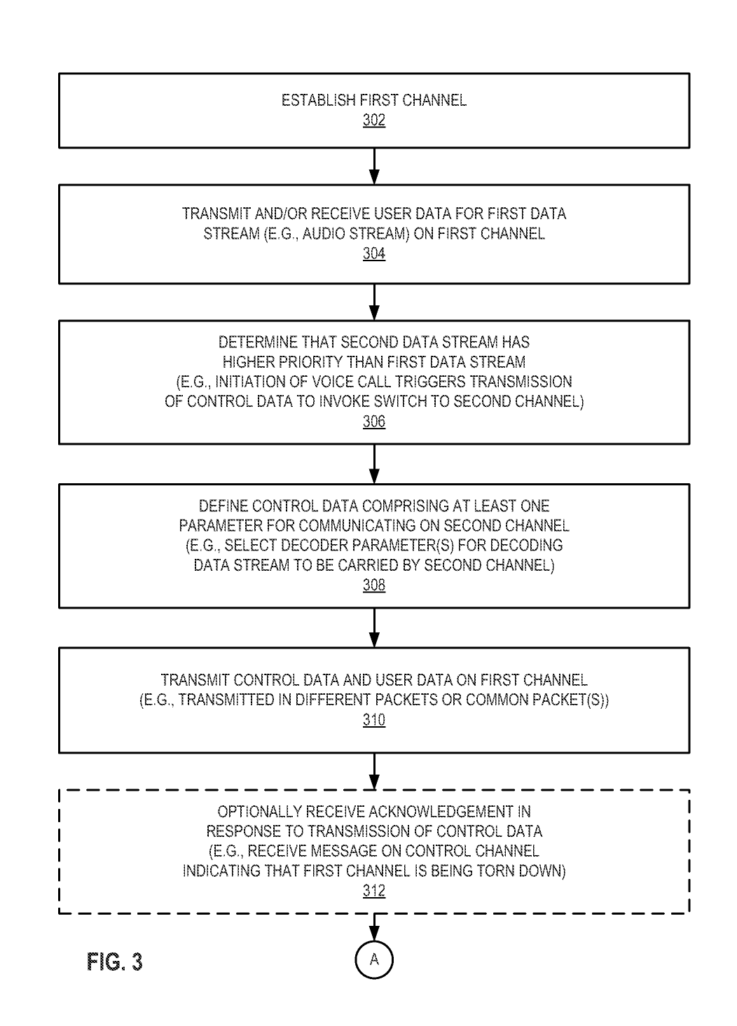

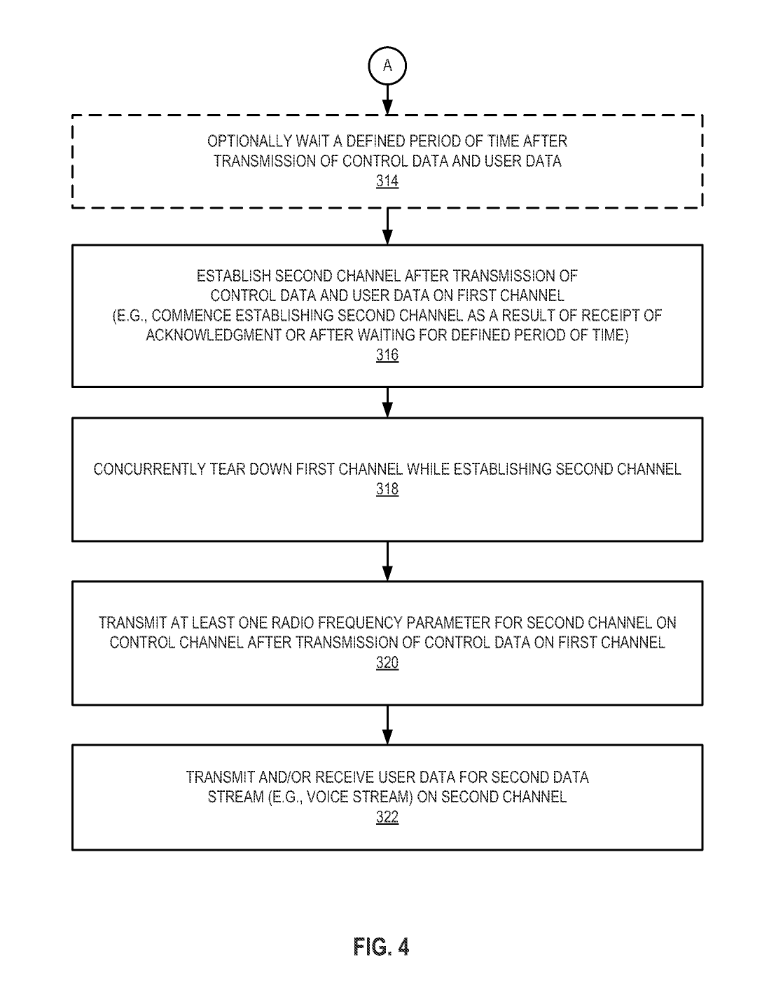

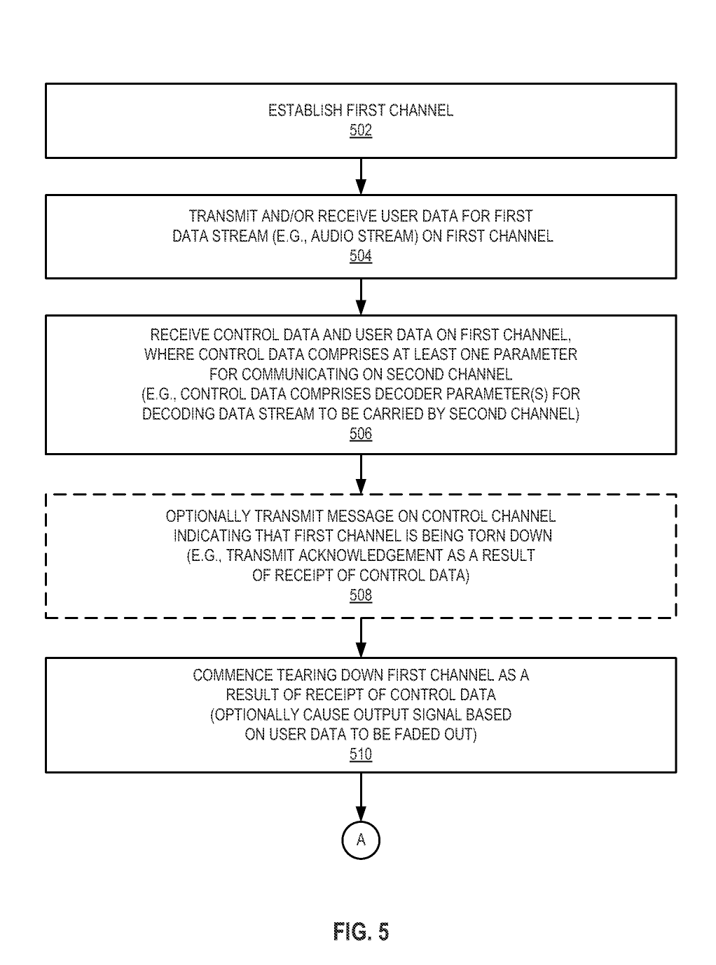

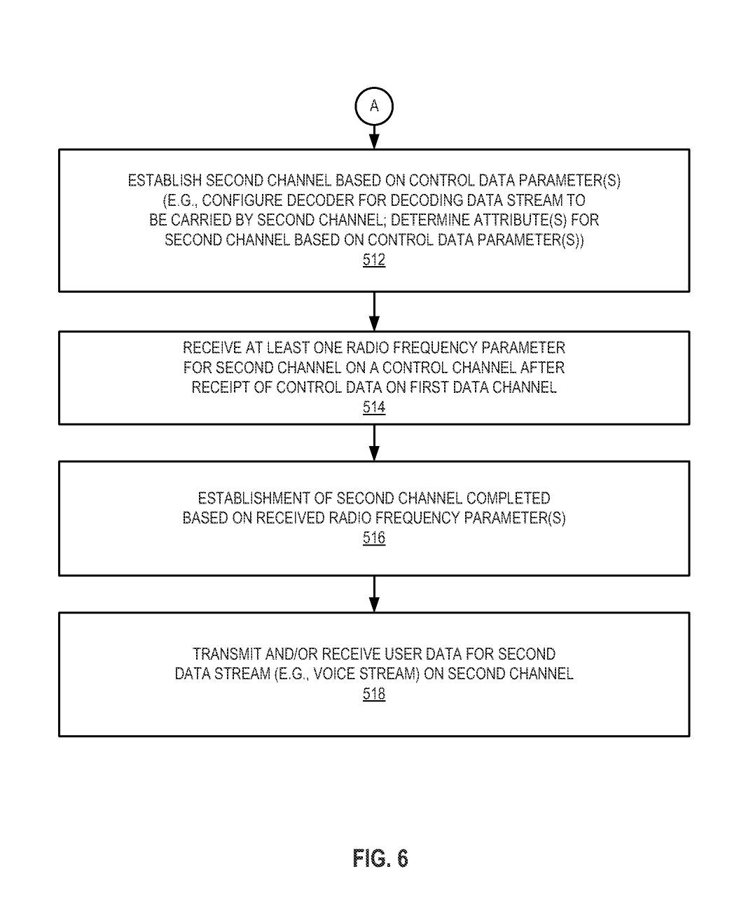

With the above in mind, FIGS. 3-6 illustrate sample operations that may be performed by different devices to provide channel switching in accordance with the teachings herein. For example, the operations of the flowchart of FIGS. 3 and 4 may correspond to operations performed by the wireless device 102 of FIG. 1 or the first device of FIG. 2. For purposes of illustration, this device will be referred to as the first device in the discussion of FIGS. 3-6. In addition, the operations of the flowchart of FIGS. 5 and 6 may correspond to operations performed by the wireless device 104 of FIG. 1 or the second device of FIG. 2. For purposes of illustration, this device will be referred to as the second device in the discussion of FIGS. 3-6. It should be appreciated based on the teachings herein, however, that any device in a communication system may perform the operations of FIGS. 3 and 4 and/or the operations of FIGS. 5 and 6.

Referring initially to FIG. 3, as represented by block 302, the first device establishes a first channel with the second device. As discussed herein, this operation may involve identifying the codec parameters to be used for a first data stream to be carried by the first channel. In addition, this operation may involve identifying the RF channel parameters to be used by the transceiver. For example, in a UWB device, a given RF channel may be defined by one or more of: pulse timing offset, operating frequency band, pseudorandom number (PN) hopping sequence, or some other parameter.

In some cases, one or more RF channel parameters may be implied by the underlying data stream parameters (e.g., codec parameters). For example, the packet size and memory resources associated with a particular data stream may imply that the RF channel support a specific data rate. Thus, in some aspects, the lower layer protocol parameters such as media access control (MAC) layer parameters and/or physical (PHY) layer parameters to be used may be implied by upper layer parameters such as application layer parameters and/or service layer parameters.

As represented by block 304, once the first channel is established, the first device transmits user data to the second device and/or receives user data from the second device on the first channel. For example, the first device may stream audio data to the second device.

As represented by block 306, at some point in time, the first device determines that a second data stream has higher priority than the first data stream. For example, phone calls or video calls may be defined (e.g., based on configuration of the first device by the user) to have a higher priority than an audio stream (e.g., a stream from a music player application). In this case, the initiation of a voice call or video call will trigger the transmission of control data to invoke a switch to a second channel that will carry the voice call data or video call data. It should be appreciated that other types of user data (and associated data streams) may be supported by devices constructed in accordance with the teachings herein. A few non-limiting examples includes audio news feeds, audio books, audio-video feeds, and so on.

Accordingly, as represented by block 308, the first device defines control data comprising at least one parameter for communication on the second channel. As discussed herein, this operation may involve selecting at least one decoder parameter that the second device will use for decoding the second data stream to be carried by the second channel.

As represented by block 310, the first device transmits the control data and user data on the first channel to the second device. That is, the first device transmits the control data in-band on a data channel, rather than on a separate control channel. The control data and user data may be carried on the first channel in various ways in different embodiments. In some cases, the first device sends the control data and user data via a common packet. In some cases, the first device sends the control data and user data via a common set of packets (e.g., each packet contains a portion of the control data and a portion of the user data). In some cases, the first device sends the control data and user data via different packets (e.g., one packet contains the control data and another packet contains the user data). It should be appreciated that the control data and user data may be carried on the first channel in other ways as well.

In some implementations, the first channel (i.e., a data channel) may not be as reliable as a control channel. For example, acknowledgements are not generally transmitted in-band for any data transmitted over a data channel. Consequently, the first device may repeatedly send the control data over the first channel to ensure that the second device receives the control data.

Blocks 312 and 314 are shown in phantom and indicated as being optional since a given implementation would typically employ the functionality of only one of these blocks. As represented by block 312, in implementations that employ an acknowledgment scheme, the first device receives an acknowledgement from the second device in response to the transmission of the control data at block 310. In some implementations, this acknowledgement takes the form of a message that indicates that the second device is tearing down the first channel.

As discussed here, the first device may receive the acknowledgment from the second device via a control channel that is separate from the first channel. For example, in a UWB system, the first channel and the control channel may be defined using different pulse timing offsets, operating frequency bands, pseudorandom number (PN) hopping sequences, some other parameters, or some combination of these parameters.

As represented by block 314 of FIG. 4, in implementations that employ a defined period of time to trigger channel reconfiguration, the first device waits a defined period of time after the time of transmission of the control data and user data at block 310. Once this period of time passes, the first device commences the reconfiguration operations.

Thus, as represented by block 316, the first device establishes the second channel some time after the transmission of the control data and the user data at block 310. For example, in some implementations, the first device commences establishing the second channel as a result of the receipt of the acknowledgement. In some implementations, the first device commences establishing the second channel prior to the receipt of the acknowledgement, but uses receipt of the acknowledgement to determine whether to complete the establishment of the second channel. That is, if the acknowledgement is not received (e.g., within a certain period of time), the first device does not complete the establishment of the second channel. Alternatively, in other implementations, the first device commences establishing the second channel after the period of time of block 314 has passed as discussed above.

From the above, it should be appreciated that the establishment of the second channel at block 316 may involve performing a portion of the operations required to fully establish the second channel. In particular, these operations may involve configuring an encoder and/or a decoder for the second channel. As discussed below at blocks 318 and 320, however, the first device may perform other operations while the second channel is being established and/or the first device may perform other operations to complete the establishment of the second channel.

Also, it should be appreciated that the second channel is a separate channel from the first channel and the control channel. For example, in a UWB system, the first channel, the control channel, and the second channel may be defined using different pulse timing offsets, operating frequency bands, pseudorandom number (PN) hopping sequences, some other parameters, or some combination of these parameters.

As represented by block 318, the first device may concurrently tear down the first channel while establishing the second channel. For example, the first device may concurrently terminate a data stream feed, reconfigure an audio codec of the first device, and reconfigure a transmitter and/or receiver of the first device.

As represented by block 320, the first device transmits at least one RF parameter for the second channel to the second device at some point in time after the transmission of the control data at block 310. As discussed herein, an RF parameter may comprise, for example, at least one timing parameter (e.g., timing offset, hopping sequence, etc.) for an RF channel and at least one encoding parameter for the RF channel. In addition, the first device may transmit an explicit instruction (e.g., in the form of a channel setup message) to the second device to establish the second channel.

The first device transmits the at least one RF parameter and/or the instruction mentioned above to the second device on a control channel. This channel may be the same control channel used at block 312 or some other control channel.

As represented by block 322, once the second channel is established by both devices, the first device transmits and/or receives user data for the second data stream on the second channel. The second channel may then remain active until a switch to another instance of the first channel (e.g., another data channel that is established in the same manner as the first channel) is indicated or a switch to some other channel is indicated. For example, the first device may be configured to switch back to a unidirectional audio data channel upon termination of a phone call or video call. In any case, operations similar to those described above are performed to accomplish this and any other subsequent channel switch.

Referring now to FIG. 5, as represented by blocks 502 and 504, the second device establishes a first channel with the first device (e.g., the device that is the subject of FIGS. 3 and 4) and transmits and/or receives user data on this channel. Thus, in general, the operations of blocks 502 and 504 are complementary to and performed in cooperation with the operations of blocks 302 and 304 discussed above.

As represented by block 506, the second device receives control data and user data on the first channel from the first device, where the control data comprises at least one parameter for communication with the first device on the second channel. As discussed herein, the parameter(s) may comprise at least one decoder parameter that the second device will use for decoding the second data stream to be carried by the second channel. The operations of block 506 may thus involve receiving the control data and user data transmitted by the first device as described above at block 310. The first device may repeatedly send the control data over the first channel to ensure that the second device receives the control data.

As represented by block 508, as a result of the receipt of the control data from the first device at block 506, the second device transmits a message to inform the first device that the first channel is being torn down in some implementations. For example, the second device may transmit an acknowledgement that acknowledges receipt of the control data. The second device may transmit the message (e.g., acknowledgement) to the first device via the control channel. The operations of block 508 may thus involve sending the information received by the first device as described above at block 312. Block 508 is shown in phantom since this message may not be sent in some implementations as discussed herein.

As represented by block 510, also as a result of the receipt of the control data at block 506, the second device commences tearing down the first channel. This involves, for example, reconfiguring the codec that was used to receive the user data on the first channel.

In some implementations, the second device employs a graceful teardown of the first channel. For example, the second device may cause the output signal based on the user data to be faded out (e.g., by ramping down the volume of the audio output by the second device) while establishing the second channel.

As represented by block 512 of FIG. 6, the second device establishes the second channel based on the at least one parameter (control data) received from the first device at block 506. Thus, the second device may configure a decoder for decoding a data stream to be received via the second channel and/or configure an encoder for encoding a data stream to be transmitted via the second channel.

In addition, in some cases, the second device determines at least one attribute for the second channel based on the at least one parameter received from the first device at block 506. As discussed above, the at least one parameter may be associated with a first communication protocol layer (e.g., an application layer or a session layer), and the at least one attribute associated with a second communication layer (e.g., a lower layer such as a MAC layer or a PHY layer). Accordingly, the second device may use the determined attribute(s) to commence configuring the second device's transceiver for communication via the second channel.

Again, it should be appreciated that the establishment of the second channel at block 512 may involve performing a portion of the operations required to establish the second channel. For example, as discussed below at blocks 514 and 516, the second device may perform other operations while the second channel is being established and/or the second device may perform other operations to complete the establishment of the second channel.

As represented by block 514, the second device receives at least one RF parameter (e.g., timing parameter and/or encoding parameter) for the second channel from the first device at some point in time after the receipt of the control data at block 506. The second device receives this RF parameter information on the control channel used at block 508 or on some other control channel. In addition, the second device may receive an explicit instruction via the control channel to establish the second channel (e.g., in the form of a channel setup message). The operations of block 514 may thus involve the second device receiving the information sent by the first device as described above at block 320.

As represented by block 516, the second device establishes the second channel based on the receipt of the at least one RF parameter at block 514. For example, the second device may configure its transmitter and receiver to use the timing and encoding specified by the RF parameter(s).

As represented by block 518, once the second channel is established by both devices, the second device transmits and/or receives user data for the second data stream on the second channel. The second channel may then remain active until a switch back to the first channel or a switch to some other channel is indicated.

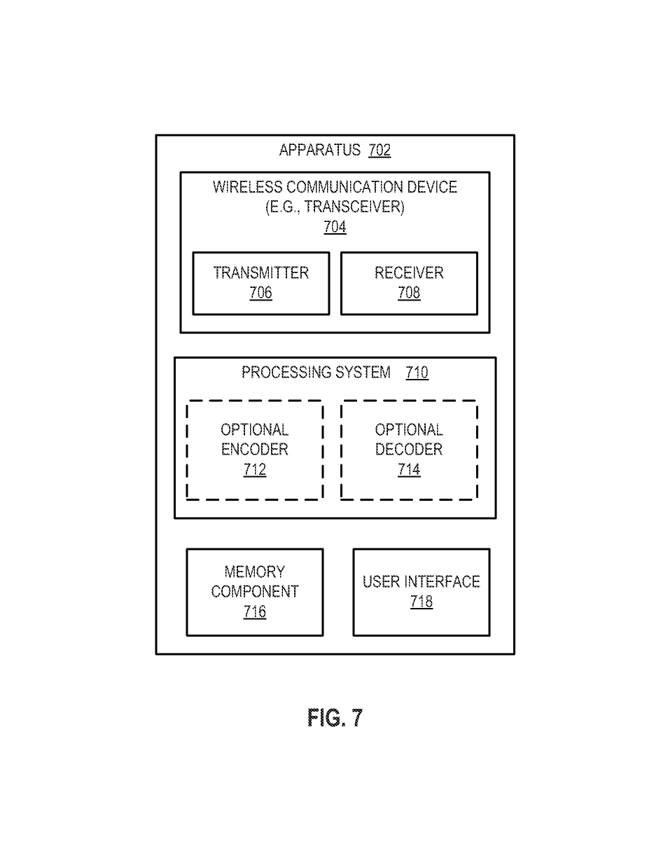

FIG. 7 illustrates several sample components (represented by corresponding blocks) that may be incorporated into an apparatus 702 (e.g., corresponding to the wireless device 102 or the wireless device 104 of FIG. 1) to perform channel switching operations as taught herein. It should be appreciated that these components may be implemented in different types of apparatuses in different implementations (e.g., in an ASIC, in a system on a chip (SoC), etc.). The described components also may be incorporated into other nodes in a communication system. For example, other nodes in a system may include components similar to those described for the apparatus 702 to provide similar functionality. Also, a given node may contain one or more of the described components. For example, an apparatus may include multiple transceiver components that enable the apparatus to operate on multiple carriers and/or communicate via different technologies.

The apparatus 702 includes at least one wireless communication device (represented by the wireless communication device 704) for communicating with other nodes via at least one designated radio access technology. The wireless communication device 704 includes at least one transmitter 706 for transmitting signals (e.g., messages, indications, control data, user data, acknowledgements, parameters, instructions, or other types of information) and at least one receiver 708 for receiving signals (e.g., messages, indications, control data, user data, acknowledgements, parameters, instructions, or other types of information).

The apparatus 702 also includes other components that are used in conjunction with channel switching operations as taught herein. For example, the apparatus 702 includes a processing system 710 for providing functionality relating to establishing channels and switching between channels (e.g., configure an encoder and/or decoder, determine channel attributes, cause output signals to be faded out, tear down channels, determine data stream priority, trigger transmission of control data, and so on) and for providing other processing functionality. In some implementations, the processing system 710 includes an encoder 712 and/or a decoder 714 (optionally implemented as a codec) to provide encoding and/or decoding operations as discussed herein. The encoder 712 and the decoder 714 are shown in phantom in FIG. 7 since these components may be implemented separately from the processing system 710 in some implementations. The apparatus 702 includes a memory component 716 (e.g., including a memory device) for maintaining information (e.g., information, thresholds, parameters, and so on). In addition, the apparatus 702 includes a user interface device 718 for providing indications (e.g., audible and/or visual indications) to a user and/or for receiving user input (e.g., upon user actuation of a sensing device such a keypad, a touch screen, a microphone, and so on).

For convenience, the apparatus 702 is shown in FIG. 7 as including components that may be used in the various examples described herein. In practice, the illustrated blocks may have different functionality in different implementations. For example, the functionality of the block 710 may be different in an implementation based on the operations of FIGS. 3 and 4 as compared to an implementation based on the operations of FIGS. 5 and 6.

The components of FIG. 7 may be implemented in various ways. In some implementations, the components of FIG. 7 are implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 704, 710, 716, and 718 may be implemented by processor and memory component(s) of the apparatus (e.g., by execution of appropriate code and/or by appropriate configuration of processor components).

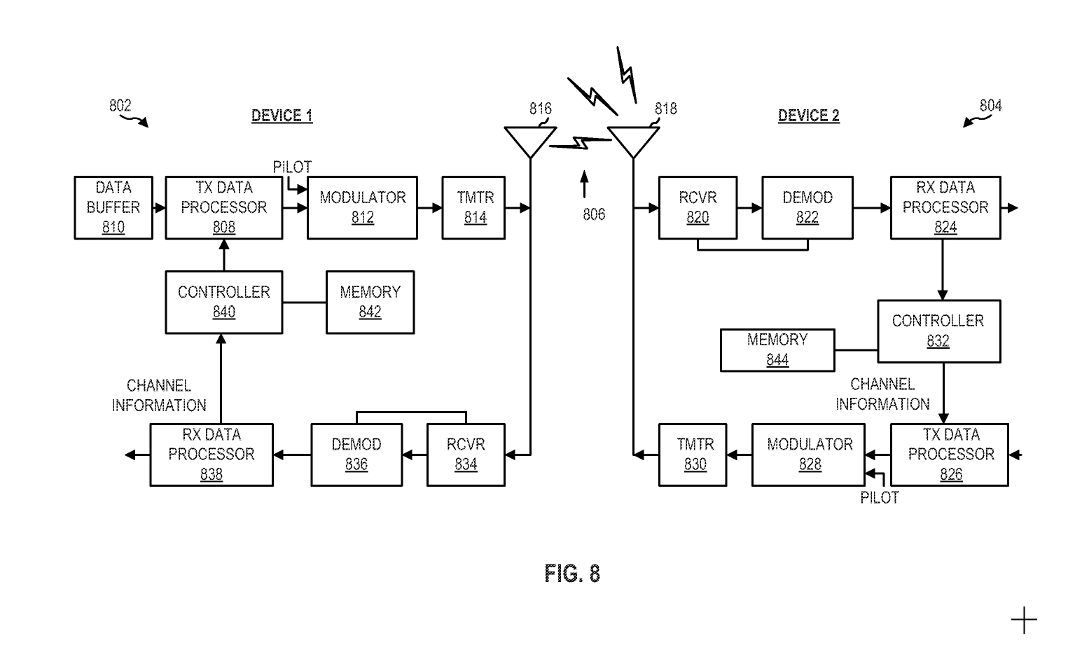

The teachings herein may be incorporated into a device employing various components for communicating with at least one other device. FIG. 8 depicts several sample components that may be employed to facilitate communication between devices. Here, a first device 802 and a second device 804 are configured to communicate via a wireless communication link 806 over a suitable medium.

Initially, components involved in sending information from the device 802 to the device 804 (e.g., via a link) will be treated. A transmit (“TX”) data processor 808 receives traffic data (e.g., data packets) from a data buffer 810 or some other suitable component. The transmit data processor 808 processes (e.g., encodes, interleaves, and symbol maps) each data packet based on a selected coding and modulation scheme, and provides data symbols. In general, a data symbol is a modulation symbol for data, and a pilot symbol is a modulation symbol for a pilot (which is known a priori). A modulator 812 receives the data symbols, pilot symbols, and possibly signaling for the link, and performs modulation (e.g., OFDM or some other suitable modulation) and/or other processing as specified by the system, and provides a stream of output chips. A transmitter (“TMTR”) 814 processes (e.g., converts to analog, filters, amplifies, and frequency upconverts) the output chip stream and generates a modulated signal, which is then transmitted from an antenna 816.

The modulated signals transmitted by the device 802 (along with signals from other devices in communication with the device 804) are received by an antenna 818 of the device 804. A receiver (“RCVR”) 820 processes (e.g., conditions and digitizes) the received signal from the antenna 818 and provides received samples. A demodulator (“DEMOD”) 822 processes (e.g., demodulates and detects) the received samples and provides detected data symbols, which may be a noisy estimate of the data symbols transmitted to the device 804 by the other device(s). A receive (“RX”) data processor 824 processes (e.g., symbol demaps, deinterleaves, and decodes) the detected data symbols and provides decoded data associated with each transmitting device (e.g., device 802).

Components involved in sending information from the device 804 to the device 802 (e.g., via a link) will be now be treated. At the device 804, traffic data is processed by a transmit (“TX”) data processor 826 to generate data symbols. A modulator 828 receives the data symbols, pilot symbols, and signaling for the link, performs modulation (e.g., OFDM or some other suitable modulation) and/or other pertinent processing, and provides an output chip stream, which is further conditioned by a transmitter (“TMTR”) 830 and transmitted from the antenna 818. In some implementations signaling for the link may include power control commands and other information (e.g., relating to a communication channel) generated by a controller 832 for all devices (e.g. terminals) transmitting on the link to the device 804.

At the device 802, the modulated signal transmitted by the device 804 is received by the antenna 816, conditioned and digitized by a receiver (“RCVR”) 834, and processed by a demodulator (“DEMOD”) 836 to obtain detected data symbols. A receive (“RX”) data processor 838 processes the detected data symbols and provides decoded data for the device 802 and the link signaling. A controller 840 may receive power control commands and other information to control data transmission and to control transmit power on the link to the device 804.

The controllers 840 and 832 direct various operations of the device 802 and the device 804, respectively. For example, a controller may determine an appropriate filter, report information about the filter, and decode information using a filter. Data memories 842 and 844 may store program codes and data used by the controllers 840 and 832, respectively.

A wireless device may include various components that perform functions based on signals that are transmitted by or received at the wireless device. For example, a wireless headset may include a transducer configured to provide an audio output based on data received via the receiver. A wireless watch may include a user interface configured to provide an indication based on data received via the receiver. A wireless sensing device may include a sensor configured to provide data to be transmitted via the transmitter.

A wireless device may communicate via one or more wireless communication links that are based on or otherwise support any suitable wireless communication technology. For example, in some aspects a wireless device may associate with a network. In some aspects the network may comprise a personal area network (e.g., supporting a wireless coverage area on the order of 30 meters) or a body area network (e.g., supporting a wireless coverage area on the order of 10 meters) implemented using ultra-wideband technology or some other suitable technology. In some aspects, the network may comprise a local area network or a wide area network. A wireless device may support or otherwise use one or more of a variety of wireless communication technologies, protocols, or standards such as, for example, CDMA, TDMA, OFDM, OFDMA, WiMAX, and Wi-Fi. Similarly, a wireless device may support or otherwise use one or more of a variety of corresponding modulation or multiplexing schemes. A wireless device may thus include appropriate components (e.g., air interfaces) to establish and communicate via one or more wireless communication links using the above or other wireless communication technologies. For example, a device may comprise a wireless transceiver with associated transmitter and receiver components that may include various components (e.g., signal generators and signal processors) that facilitate communication over a wireless medium.

In some aspects, a wireless device may communicate via an impulse-based wireless communication link. For example, an impulse-based wireless communication link may utilize ultra-wideband pulses that have a relatively short length (e.g., on the order of a few nanoseconds or less) and a relatively wide bandwidth. In some aspects, the ultra-wideband pulses may have a fractional bandwidth on the order of approximately 20% or more and/or have a bandwidth on the order of approximately 500 MHz or more.

The teachings herein may be incorporated into (e.g., implemented within or performed by) a variety of apparatuses (e.g., devices). For example, one or more aspects taught herein may be incorporated into a phone (e.g., a cellular phone), a personal data assistant (PDA), an entertainment device (e.g., a music or video device), a headset (e.g., headphones, an earpiece, etc.), a microphone, a medical sensing device (e.g., a sensor such as a biometric sensor, a heart rate monitor, a pedometer, an EKG device, a smart bandage, a vital signal monitor, etc.), a user I/O device (e.g., a watch, a remote control, a switch such as a light switch, a keyboard, a mouse, etc.), an environment sensing device (e.g., a tire pressure monitor), a monitor that may receive data from the medical or environment sensing device, a computer, a point-of-sale device, an entertainment device, a hearing aid, a set-top box, a gaming device, or any other suitable device. The communication devices described herein may be used in any type of sensing application, such as for sensing automotive, athletic, and physiological (medical) responses. Any of the disclosed aspects of the disclosure may be implemented in many different devices. For example, in addition to medical applications as discussed above, the aspects of the disclosure may be applied to health and fitness applications. Additionally, the aspects of the disclosure may be implemented in shoes for different types of applications. There are other multitudes of applications that may incorporate any aspect of the disclosure as described herein.

These devices may have different power and data requirements. In some aspects, the teachings herein may be adapted for use in low power applications (e.g., through the use of an impulse-based signaling scheme and low duty cycle modes) and may support a variety of data rates including relatively high data rates (e.g., through the use of high-bandwidth pulses).

In some aspects, a wireless device may comprise an access device (e.g., an access point) for a communication system. Such an access device may provide, for example, connectivity to another network (e.g., a wide area network such as the Internet or a cellular network) via a wired or wireless communication link. Accordingly, the access device may enable another device (e.g., a wireless station) to access the other network or some other functionality. In addition, it should be appreciated that one or both of the devices may be portable or, in some cases, relatively non-portable. Also, it should be appreciated that a wireless device also may be capable of transmitting and/or receiving information in a non-wireless manner (e.g., via a wired connection) via an appropriate communication interface.

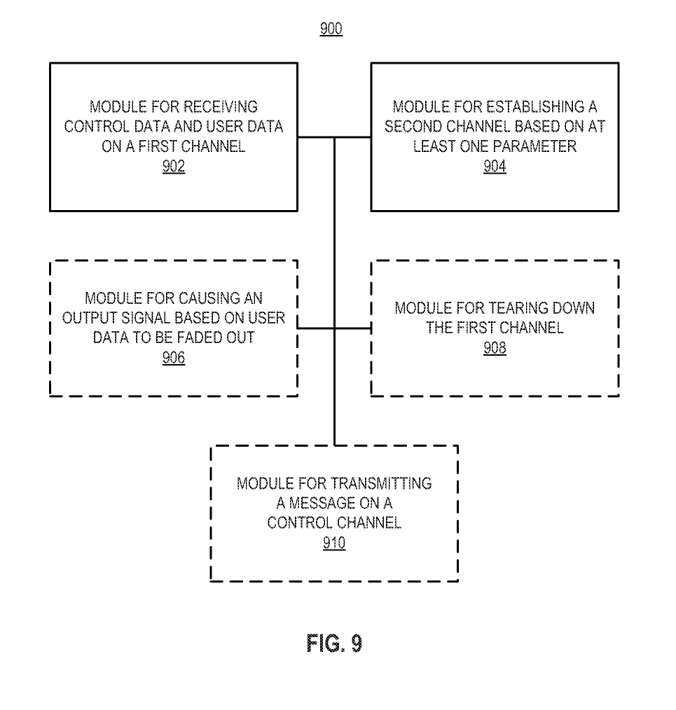

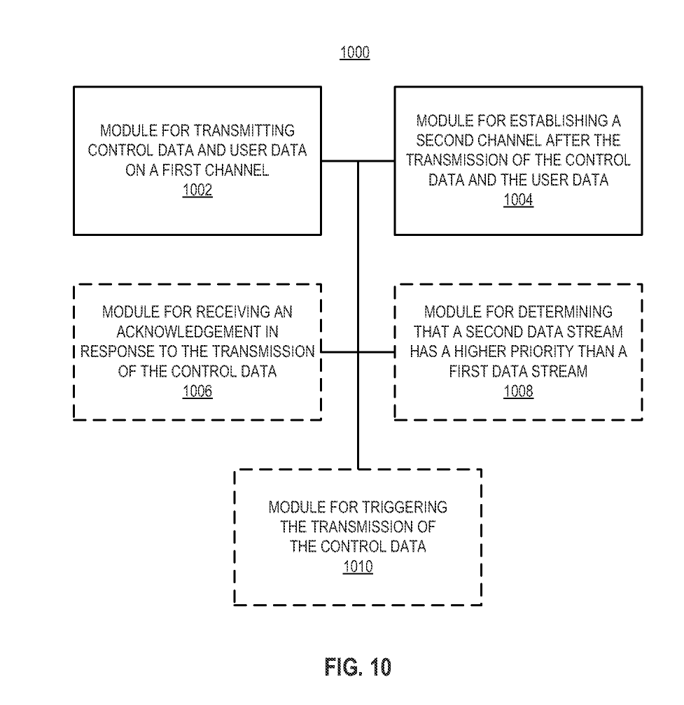

The components described herein may be implemented in a variety of ways. Referring to FIGS. 9 and 10, apparatuses 900 and 1000 are represented as a series of interrelated functional blocks that may represent functions implemented by hardware, software, or a combination of hardware and software. For example, the blocks may be implemented by one or more integrated circuits (e.g., an ASIC) or may be implemented in some other manner as taught herein. As discussed herein, an integrated circuit may include a processor, software, other components, or some combination thereof.

The apparatuses 900 and 1000 include one or more modules that may perform one or more of the functions described above with regard to various figures. For example, a module for receiving control data and user data on a first channel 902 may correspond to, for example, a communication device as discussed herein (e.g., transceiver 118, receiver 708). A module for establishing a second channel based on at least one parameter 904 may correspond to, for example, a processing system as discussed herein (e.g., processing system 710, controller 126). A module for causing an output signal based on user data to be faded out 906 may correspond to, for example, a processing system as discussed herein (e.g., processing system 710, controller 126, processing system 710 and user interface 718, controller 126 and user interface 132). A module for tearing down the first channel 908 may correspond to, for example, a processing system as discussed herein (e.g., processing system 710, controller 126). A module for transmitting a message on a control channel 910 may correspond to, for example, a communication device (e.g., transceiver 118, transmitter 706) as discussed herein.

A module for transmitting control data and user data on a first channel 1002 may correspond to, for example, a communication device as discussed herein (e.g., transceiver 116, transmitter 706). A module for establishing a second channel after the transmission of the control data and the user data 1004 may correspond to, for example, a processing system as discussed herein (e.g., controller 124, processing system 710). A module for receiving an acknowledgement in response to the transmission of the control data 1006 may correspond to, for example, a communication device system as discussed herein (e.g., transceiver 116, receiver 708). A module for determining that a second data stream has a higher priority than a first data stream 1008 may correspond to, for example, a processing system as discussed herein (e.g., controller 124, processing system 710). A module for triggering the transmission of the control data 1010 may correspond to, for example, a processing system as discussed herein (e.g., controller 124, processing system 710).

As noted above, in some aspects these modules may be implemented via appropriate processor components. These processor components may in some aspects be implemented, at least in part, using structure as taught herein. In some aspects a processor may be configured to implement a portion or all of the functionality of one or more of these modules. Thus, the functionality of different modules may be implemented, for example, as different subsets of an integrated circuit, as different subsets of a set of software modules, or a combination thereof. Also, it should be appreciated that a given subset (e.g., of an integrated circuit and/or of a set of software modules) may provide at least a portion of the functionality for more than one module. In some aspects one or more of any components represented by dashed boxes are optional. Furthermore, in some aspects, the modules may be implemented as application specific hardware (e.g., one or more integrated circuit chips, one or more ASICs, etc.).

As noted above, the apparatuses 900 and 1000 may comprise one or more integrated circuits. For example, in some aspects a single integrated circuit may implement the functionality of one or more of the illustrated components, while in other aspects more than one integrated circuit may implement the functionality of one or more of the illustrated components.

In addition, the components and functions represented by FIGS. 9 and 10 as well as other components and functions described herein, may be implemented using any suitable means. Such means also may be implemented, at least in part, using corresponding structure as taught herein. For example, the components described above in conjunction with the “module for” components of FIGS. 9 and 10 also may correspond to similarly designated “means for” functionality. Thus, in some aspects one or more of such means may be implemented using one or more of processor components, integrated circuits, or other suitable structure as taught herein.

Also, it should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by a processing system, an integrated circuit (“IC”), an access terminal, or an access point. A processing system may be implemented using one or more ICs or may be implemented within an IC (e.g., as part of a system on a chip). An IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes (e.g., executable by at least one computer) relating to one or more of the aspects of the disclosure. In some aspects, a computer program product may comprise packaging materials.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A computer-readable media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media such as a storage media). In addition, in some aspects computer readable medium may comprise transitory computer readable medium (e.g., comprising a signal). Combinations of the above should also be included within the scope of computer-readable media. It should be appreciated that a computer-readable medium may be implemented in any suitable computer-program product.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

1. An apparatus for wireless communication, comprising:
a communication device configured to receive control data and user data on a first channel, wherein the control data comprises at least one parameter for communicating on a second channel; and
a processing system configured to establish the second channel based on the at least one parameter.

2. The apparatus of claim 1, wherein:
the processing system comprises a decoder;
the at least one parameter comprises at least one decoder parameter for the decoder; and
the establishment of the second channel comprises configuring the decoder for decoding a data stream to be carried by the second channel.

3. (canceled)

4. The apparatus of claim 3, wherein the establishment of the second channel comprises determining, based on the at least one parameter, at least one attribute for the second channel.

5. The apparatus of claim 4, wherein:
the at least one parameter is associated with a first communication protocol layer; and
the at least one attribute for the second channel is associated with a second communication protocol layer that is a lower layer than the first communication protocol layer.

6. The apparatus of claim 3, wherein:
the communication device is further configured to receive at least one radio frequency parameter on a control channel after the receipt of the control data; and
the processing system is further configured to establish the second channel based on the received at least one radio frequency parameter.

7. The apparatus of claim 6, wherein the communication device is further configured to receive, on the control channel, an instruction to establish the second channel.

8. The apparatus of claim 1, wherein:
the user data on the first channel is associated with a first data stream; and
the second channel is established for a second data stream that is different from the first data stream and wherein the first data stream carries a different type of data than the second data stream.

9. (canceled)

10. The apparatus of claim 1, wherein the processing system is further configured to cause an output signal based on the user data to be faded out as a result of the receipt of the control data.

11. The apparatus of claim 1, wherein the processing system is further configured to tear down the first channel as a result of the receipt of the control data.

12. The apparatus of claim 1, wherein:
the communication device is further configured to transmit a message on a control channel as a result of the receipt of the control data; and
the message indicates that the first channel is being torn down.

13. The apparatus of claim 1, wherein the reception of the control data and the user data comprises receiving at least one packet containing the control data and the user data.

14. The apparatus of claim 1, wherein:
the first channel and the second channel comprise radio frequency channels;
the processing system comprises a decoder;
the at least one parameter comprises at least one decoder parameter for the decoder;
the user data on the first channel is associated with a first data stream;
the second channel is established for a second data stream that is different from the first data stream; and
the establishment of the second channel comprises configuring the decoder for decoding the second data stream.

15. A method for wireless communication, comprising:
receiving control data and user data on a first channel, wherein the control data comprises at least one parameter for communicating on a second channel; and
establishing the second channel based on the at least one parameter.

16. The method of claim 15, wherein:
the at least one parameter comprises at least one decoder parameter for a decoder; and
the establishment of the second channel comprises configuring the decoder for decoding a data stream to be carried by the second channel.

17. (canceled)

18. The method of claim 17, wherein the establishment of the second channel comprises determining, based on the at least one parameter, at least one attribute for the second channel; and wherein:
the at least one parameter is associated with a first communication protocol layer; and
the at least one attribute for the second channel is associated with a second communication protocol layer that is a lower layer than the first communication protocol layer.

19. (canceled)

20. The method of claim 17, further comprising receiving at least one radio frequency parameter on a control channel after the receipt of the control data, wherein the establishment of the second channel is further based on the received at least one radio frequency parameter.

21. The method of claim 20, further comprising receiving, on the control channel, an instruction to establish the second channel, wherein the establishment of the second channel is further based on the receipt of the instruction.

22. The method of claim 15, wherein:
the user data on the first channel is associated with a first data stream; and
the second channel is established for a second data stream that is different from the first data stream and wherein the first data stream carries a different type of data than the second data stream.

23. (canceled)

24. The method of claim 15, further comprising causing an output signal based on the user data to be faded out as a result of the receipt of the control data.

25. The method of claim 15, further comprising tearing down the first channel as a result of the receipt of the control data.

26. The method of claim 15, further comprising transmitting a message on a control channel as a result of the receipt of the control data, wherein the message indicates that the first channel is being torn down.

27. The method of claim 15, wherein the reception of the control data and the user data comprises receiving at least one packet containing the control data and the user data.

28. The method of claim 15, wherein:
the first channel and the second channel comprise radio frequency channels;
the at least one parameter comprises at least one decoder parameter for a decoder;
the user data on the first channel is associated with a first data stream;
the second channel is established for a second data stream that is different from the first data stream; and
the establishment of the second channel comprises configuring the decoder for decoding the second data stream.

29. An apparatus for wireless communication, comprising:
means for receiving control data and user data on a first channel, wherein the control data comprises at least one parameter for communicating on a second channel; and
means for establishing the second channel based on the at least one parameter.

30. The apparatus of claim 29, wherein:
the apparatus further comprises a means for decoding;
the at least one parameter comprises at least one decoder parameter for the means for decoding; and
the establishment of the second channel comprises configuring the means for decoding for decoding a data stream to be carried by the second channel.

31-33. (canceled)

34. The apparatus of claim 31, wherein:
the means for receiving is configured to receive at least one radio frequency parameter on a control channel after the receipt of the control data; and
the establishment of the second channel is further based on the received at least one radio frequency parameter.

35. The apparatus of claim 34, wherein:
the means for receiving is further configured to receive, on the control channel, an instruction to establish the second channel; and
the establishment of the second channel is further based on the receipt of the instruction.

36. The apparatus of claim 29, wherein:
the user data on the first channel is associated with a first data stream; and
the second channel is established for a second data stream that is different from the first data stream and wherein the first data stream carries a different type of data than the second data stream.

37. (canceled)

38. The apparatus of claim 29, further comprising means for causing an output signal based on the user data to be faded out as a result of the receipt of the control data.

39. The apparatus of claim 29, further comprising means for tearing down the first channel as a result of the receipt of the control data.

40-42. (canceled)

43. A computer-program product for wireless communication, comprising:
computer-readable medium comprising codes executable to:
receive control data and user data on a first channel, wherein the control data comprises at least one parameter for communicating on a second channel; and
establish the second channel based on the at least one parameter.

44. An apparatus for wireless communication, comprising:
a communication device configured to transmit control data and user data on a first channel, wherein the control data comprises at least one parameter for communicating on a second channel; and
a processing system configured to establish the second channel after the transmission of the control data and the user data.

45. The apparatus of claim 44, wherein:
the communication device is further configured to receive an acknowledgement in response to the transmission of the control data; and
the processing system is further configured to establish the second channel as a result of the receipt of the acknowledgement.

46. The apparatus of claim 45, wherein the acknowledgement comprises a message that indicates that the first channel is being torn down.

47. The apparatus of claim 44, wherein:
the transmission of the control data and the user data is associated with a time; and
the processing system is further configured to establish the second channel a defined period of time after the time associated with the transmission of the control data and the user data.

48. The apparatus of claim 44, wherein the processing system is further configured to concurrently tear down the first channel while establishing the second channel.

49. The apparatus of claim 44, wherein:
the user data is associated with a first data stream;
the processing system is further configured to determine that a second data stream has a higher priority than the first data stream; and
the processing system is further configured to trigger the transmission of the control data as a result of the determination that the second data stream has a higher priority than the first data stream.

50. (canceled)

51. The apparatus of claim 50, wherein:
the communication device is further configured to transmit at least one radio frequency parameter for the second channel on a control channel; and
the at least one radio frequency parameter is transmitted after the transmission of the control data and the user data.

52. The apparatus of claim 51, wherein the communication device is further configured to transmit, on the control channel, an instruction to establish the second channel.

53. The apparatus of claim 44, wherein the at least one parameter is for configuring a decoder to decode a data stream to be carried by the second channel.

54. The apparatus of claim 44, wherein:
the user data on the first channel is associated with a first data stream; and
the second channel is established for a second data stream that is different from the first data stream and wherein the first data stream carries a different type of data than the second data stream.

55. (canceled)

56. The apparatus of claim 44, wherein the transmission of the control data and the user data on the first channel comprises transmitting at least one packet containing the control data and the user data.

57. The apparatus of claim 44, wherein:
the first channel and the second channel comprise radio frequency channels;
the user data on the first channel is associated with a first data stream;
the second channel is established for a second data stream that is different from the first data stream; and
the at least one parameter is for configuring a decoder to decode the second data stream.

58. A method of wireless communication, comprising:
transmitting control data and user data on a first channel, wherein the control data comprises at least one parameter for communicating on a second channel; and
establishing the second channel after the transmission of the control data and the user data.

59. The method of claim 58, further comprising receiving an acknowledgement in response to the transmission of the control data, wherein the second channel is established as a result of the receipt of the acknowledgement.

60. (canceled)

61. The method of claim 58, wherein:
the transmission of the control data and the user data is associated with a time; and
the second channel is established a defined period of time after the time associated with the transmission of the control data and the user data.

62. The method of claim 58, further comprising concurrently tearing down the first channel while establishing the second channel.

63. The method of claim 58, wherein the user data is associated with a first data stream, the method further comprising:
determining that a second data stream has a higher priority than the first data stream; and
triggering the transmission of the control data as a result of the determination that the second data stream has a higher priority than the first data stream.

64-71. (canceled)

72. An apparatus for wireless communication, comprising:
means for transmitting control data and user data on a first channel, wherein the control data comprises at least one parameter for communicating on a second channel; and
means for establishing the second channel after the transmission of the control data and the user data.

73. The apparatus of claim 72, further comprising means for receiving an acknowledgement in response to the transmission of the control data, wherein the second channel is established as a result of the receipt of the acknowledgement.

74. (canceled)

75. The apparatus of claim 72, wherein:
the transmission of the control data and the user data is associated with a time; and
the second channel is established a defined period of time after the time associated with the transmission of the control data and the user data.

76. The apparatus of claim 72, wherein the means for establishing the second channel is configured to concurrently tear down the first channel while establishing the second channel.

77. The apparatus of claim 72, wherein the user data is associated with a first data stream, the apparatus further comprising:
means for determining that a second data stream has a higher priority than the first data stream; and
means for triggering the transmission of the control data as a result of the determination that the second data stream has a higher priority than the first data stream.

78-85. (canceled)

86. A computer-program product for wireless communication, comprising:
computer-readable medium comprising codes executable to:
transmit control data and user data on a first channel, wherein the control data comprises at least one parameter for communicating on a second channel; and
establish the second channel after the transmission of the control data and the user data.
